(19) United States
(12) Patent Application Publication
(10) Pub. No.: US 2014/0054085 A1
(43) Pub. Date: Feb. 27, 2014

(54) Cable Assembly Comprising A Flexible Support Made From A Textile Material

(71) Applicant: TYCO ELECTRONICS NEDERLAND BV, S-Hertogenbosch (NE)

(72) Inventors: Wilfred Vermeulen, EL Heeswijk-Dinther (NE); Jan Van Tilburg, GJ Oss (NE)

(73) Assignee: TYCO ELECTRONICS NEDERLAND BV, S-Hertogenbosch (NE)

(21) Appl. No.: 14/066,237

(22) Filed: Oct. 29, 2013

Related U.S. Application Data
(63) Continuation of application No. PCT/EP2012/057451, filed on Apr. 24, 2012.

(30) Foreign Application Priority Data
Apr. 24, 2011 (EP) 11164332.6

(51) Int. Cl. H01B 7/02; G02B 6/44; H01B 19/00; H01B 11/22

(52) U.S. Cl. CPC H01B 7/02; H01B 11/22; G02B 6/4416; H01B 19/00
USPC 174/70 R; 174/124 R; 174/120 R; 29/825; 139/383 R; 112/475.17

(57) ABSTRACT

A cable assembly is provided that includes a plurality of conductor strands and a flexible support having a textile material into which the plurality of conductor strands are integrated and secured.

### CROSS-REFERENCE TO RELATED APPLICATIONS

This application claims the benefit of the filing date under 35 U.S.C. §119(a)-(d) of PCT Patent Application No. PCT/EP2012/057451 filed on Apr. 24, 2012. which claims priority under 35 U.S.C. §119 to EP Application 11164332.6, filed Apr. 29, 2011.

### FIELD OF INVENTION

The present invention relates to a cable assembly and, more particularly, to a cable assembly having a flexible support.

### BACKGROUND

Typically, stranded wires are used in cable assemblies to transfer data or power. Manufacturing such cable assemblies, as cable harnesses, is a time consuming and difficult. Special tools are generally developed, such as lay-out boards, for each individual harness. The individual wires are held together by a wrapping or coating, which is also a time consuming and operator sensitive operation. The wrapping also adds stiffness to the cable, making it less flexible. Hence, the construction of cables is cost, material and labor intensive.

Traditional manufacturing methods for cable assemblies use different process steps to build the cable assembly, such as drawing and extrusion equipment for the conductors, taping equipment for the shield, braiding equipment for the braid, and extrusion equipment for the jacket. These processes require specific material properties and the range of possible materials that can be used is limited.

### SUMMARY

The present invention has been made to overcome or alleviate at least one aspect of the above mentioned disadvantages, among others. Accordingly, a flexible cable assembly is provided.

The cable assembly includes a plurality of conductor strands and a flexible support having a textile material into which the plurality of conductor strands are integrated and secured.

### BRIEF DESCRIPTION OF THE DRAWINGS

The above and other features of the present invention will become more apparent by describing in detail exemplary embodiments thereof with reference to the accompanying drawings, in which:

FIG. 1 is a perspective view of a cable assembly according to the invention;

FIG. 2 shows a cross-sectional view of the cable assembly of FIG. 1 along the section line 2-2;

FIG. 3 is a perspective view of another cable assembly according to the invention;

FIG. 4 is a cross-sectional view of the cable assembly of FIG. 3 taken along the section line 4-4;

FIG. 5 is a top view of another cable assembly according to the invention;

FIG. 6 is a cut out section of the cable assembly of FIG. 5;

FIG. 7 is a partial top view of a cable assembly according to the invention;

FIG. 8 is a cross-sectional view of another cable assembly according to the invention;

FIG. 9 is another cross-sectional view of the cable assembly of FIG. 8 after wrapping a textile material around the conductor strands;

FIG. 10 is a cross-sectional view of another cable assembly according to the invention;

FIG. 11 is another cross-sectional view of the cable assembly of FIG. 10 in the assembled state;

FIG. 12 is a cross-sectional view of another cable assembly according to the invention;

FIG. 13 is a cross-sectional view of another cable assembly according to the invention;

FIG. 14 is another cross-sectional view of the cable assembly of FIG. 13 in the assembled state;

FIG. 15 is a cross-sectional view of another cable assembly according to the invention;

FIG. 16 is another cross-sectional view of the cable assembly of FIG. 15 in the assembled state;

FIG. 17 is a perspective view of another embodiment of the cable assembly according to the invention;

FIG. 18 is a perspective view of another cable assembly according to the invention; and

FIG. 19 is another perspective view of the cable assembly of FIG. 18 during the shaping of the cable assembly.

### DETAILED DESCRIPTION OF THE EMBODIMENT(S)

Exemplary embodiments of the invention will be described hereinafter in detail with reference to the attached drawings, wherein the like reference numerals refer to the like elements. The present invention may, however, be embodied in many different forms and should not be construed as being limited to the embodiment set forth herein; rather, these embodiments are provided so that the present disclosure will be thorough and complete, and will fully convey the concept of the disclosure to those skilled in the art.

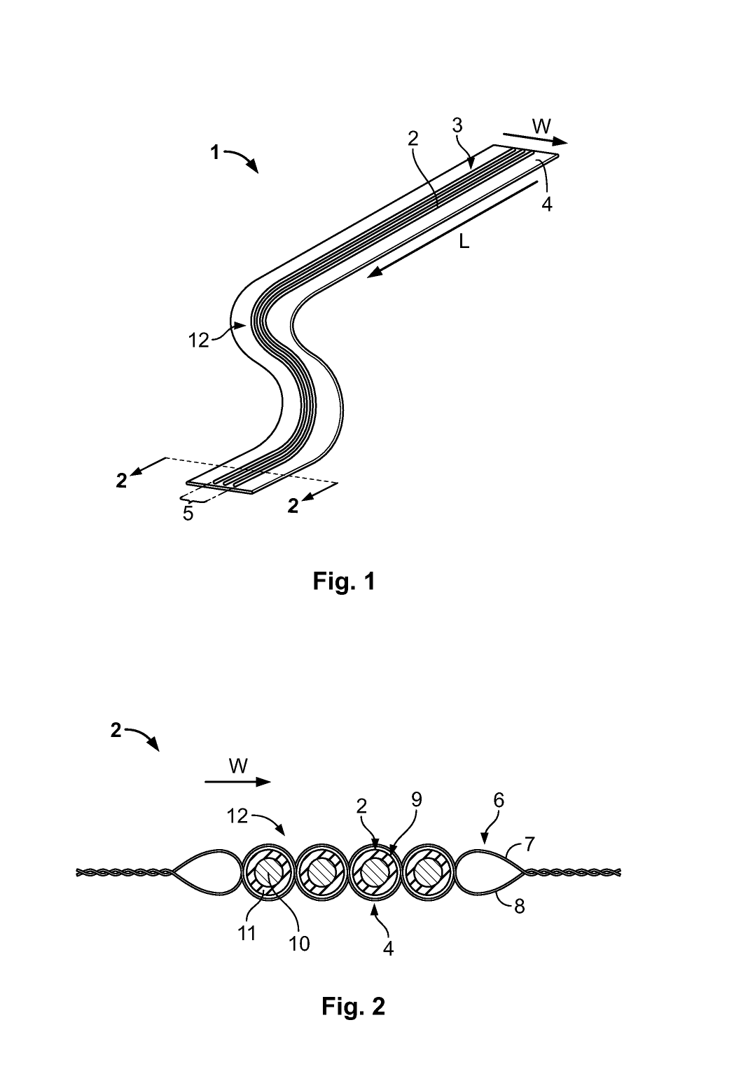

With reference to FIGS. 1 and 2, a cable assembly 1 is shown that includes a plurality, of conductor strands 2 that are integrated in a flexible support 3 made from a textile material 4.

The shown cable assembly 1 may be designed as a flat-type ribbon cable assembly 1 that is highly flexible. The individual conductor strands 2 are integrated in the textile material 4 by weaving the conductor strands 2 with the weaving pattern of the textile material 4 parallel to each other, side by side the so-called supporting zone 5 of the cable assembly 1. The conductor strands 2 run substantially in the longitudinal direction L of the ribbon cable assembly 1. The supporting zone 5 is defined as the area of the textile material 4, in which the conductor strands 2 are integrated. The textile material 4 extend laterally, along a width w, over the supporting zone 5 of the cable assembly 1.

The textile material 4 is a woven fabric that is composed of a fiber or yarn material 6. The conductor strands 2 are woven such in the textile material 4 that the fibers 6 interlay with the conductor strands 2. This interlacing structure provides the integration of the conductor strands 2 in the textile material 4.

In the shown embodiment, the textile material 4 includes two different fibers, namely an aramide fiber, such as a Nomex or Kevlar fiber 7 and a cotton fiber 8.

The use of an aramide fiber 7 strengthens the textile material 4 providing a high durability and protection against wear so that the ultra-thin highly flexible cable assembly 1 can even be used in dynamic applications, such as a robotics. The use of a cotton fiber 8 or another natural fiber is advantageous from the environmental perspective, since cotton is an environmentally friendly material.

The individual conductor strands 2 of the cable assembly 1 are electrical wires 9 having a lead 10 and a thin insulation coating 11 encapsulating the lead 10. By weaving the conductor strands 2 into the textile material 4, the conductor strands 2 can be secured to the flexible support 3 in a defined conductor pattern 12. In the shown conductor pattern 12, the conductor strands 2 are arranged substantially parallel to each other and adjacent to one another in the style of the wires of a ribbon cable.

By weaving the conductor strands 2 or conductors into the textile material 4, the individual conductor strands 2 or conductors can be located at the intended position. In particular, the conductor strands 2 or conductors can be secured to the flexible support 3 in a defined conductor pattern 12, allowing an easy manufacturing of, e.g. cable harnesses of a flat-type cable or even “PCB”-like cable harnesses, wherein the individual conductive strands 2 or conductors are running such that terminating the strands 2 or conductors to one or more connectors 15 at each end or to an electrical device is facilitated and specifically designed for the intended purpose. This contributes to the great versatility of the cable assembly 1 according to the present invention.

Principally, the fabric of the textile material 4 can be composed of a material selected from the group comprising cotton, hemp, jute, flax, ramie, sisal, animal fibers, mineral fibers, rayon, modal, lyocell fibers, cellulose fibers, silica fibers, polymer fibers like nylon, aramide fibers, or a combination thereof. The material of the fabric is, however, not limited to this list of possible materials, as long as a textile can be formed from the fiber that has the desired properties.

In the foregoing described embodiments of the cable assembly 1, elements having a similar or identical structure/function as elements of the aforementioned embodiment have the same reference signs. For sake of brevity, only differences between the previously described embodiment of the cable assembly 1 with respect to the foregoing embodiments are described.

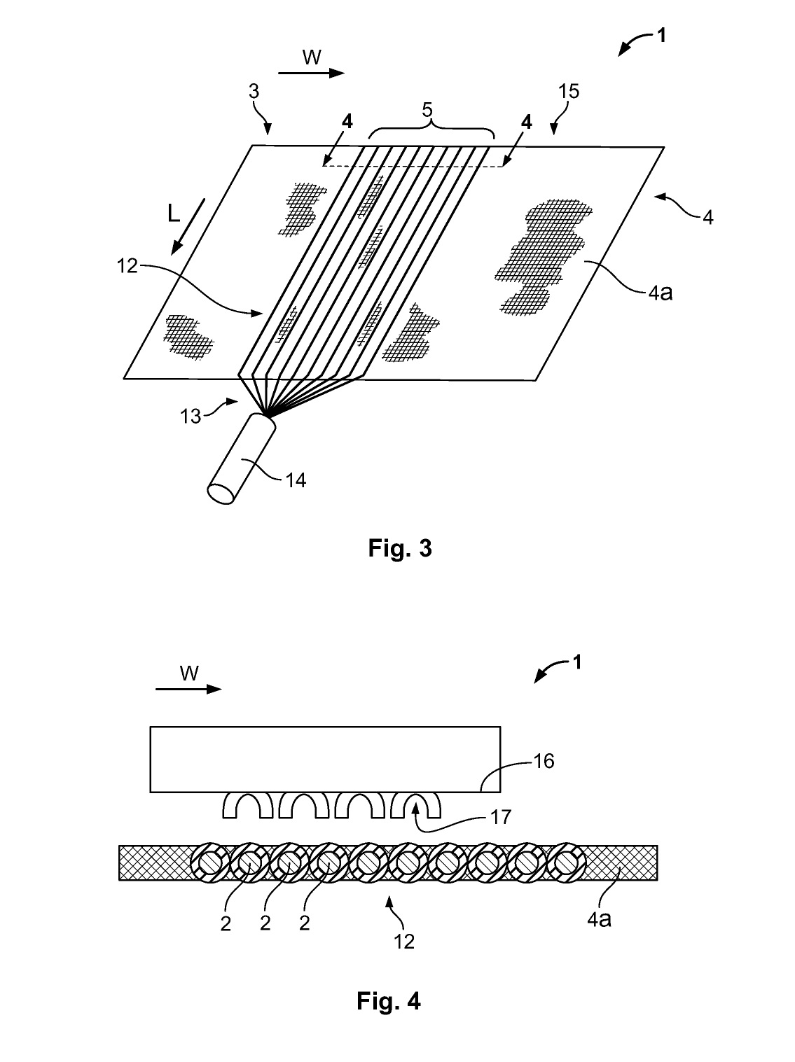

Now with reference to FIGS. 3 and 4, the shown cable assembly 1 includes the plurality of conductors strands 2 woven into the supporting zone 5 of the textile material 4 substantially parallel with each other and running along the longitudinal direction L.

The individual conductor strands 2 are brought together outside the woven fabric 4a of which the textile material 4 is composed, at a first end 13 of the cable assembly 1. The combined strands 2 at the first end 13 are crimped together and terminated to a first connector 14.

At the second end 15 of the cable assembly 1, the conductor strands 2 are terminated using a connector of the piercing type, such as an insulation-displacement connector 16 which can easily terminate a plurality, if necessary all, of the cable strands 2 at once by simple forcing the blade portion 17 thereof through the insulation, bypassing the need to strip the wire of its insulation before connecting. Due to the defined conductor pattern 12 in which the conductor strands 2 are arranged and that can be easily adapted to piercing type of connectors 16, the termination of the conductor strands 2 is facilitated.

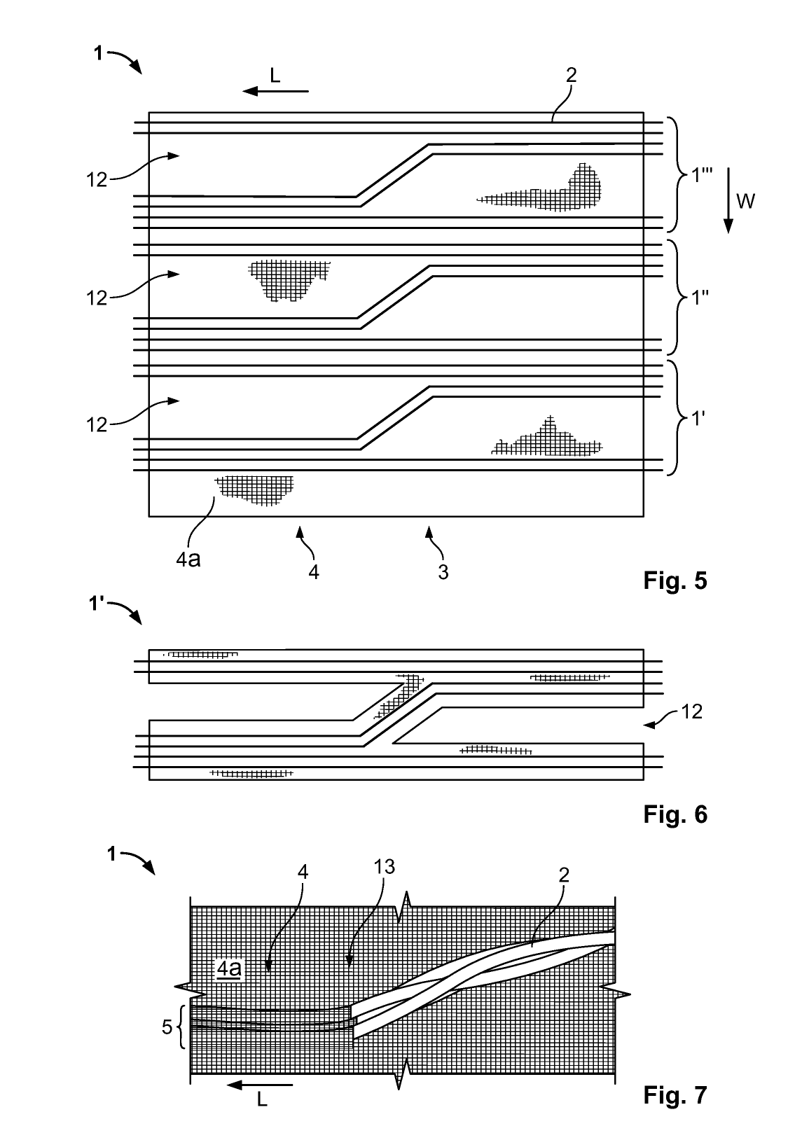

Now with reference to FIG. 5, the cable assembly 1 is designed as a flexible flat cable. The conductor strands 2 are integrated in the flexible support 3 in a defined conductor pattern 12, in which the individual conductor strands 2 substantially run in the longitudinal direction adjacent to one another. The conductor pattern 12 of FIG. 5 differs from the previous patterns in that not all conductor strands 2 run substantially parallel with each other. Rather, the conductor strands 2 are arranged in a more complex pattern resembling a simple wiring flow of a circuit board. This pattern provides a simple example of the possibilities of arbitrarily arranging and building even very complex conductor patterns 12 according to the invention. Using common weaving technologies, such as Jacquard weaving, even very complex conductor patterns 12 of the conductor strands 2 can be easily woven into the flexible support 3.

FIG. 5 further shows that in a textile material 4 having a sufficient width, a plurality of repeating or different cable assembly units 1′, 1″, 1′″ can be manufactured side by side.

By simply cutting out the individual conductor strand subunits 1′, 1″, 1′″, for example using laser cutting, the individual cable assembly units 1′, 1″, 1′″ can be separated from one another and be further processed, for example terminated to one or more connectors 15, 16.

In FIGS. 5 and 6, a method for producing a cable assembly 1 is demonstrated, comprising the steps of integrating the multiple conductor strands 2 in the textile material 4 of the flexible support 3 in a predetermined conductor pattern 2 by weaving them into the textile material 4, and shaping the textile material 4 into the cable assembly 1 by cutting out the cable assembly units 1′, 1″, 1′″.

Now with reference to FIG. 7, the individual conductor strands 2 are shown exiting the textile material 4. In FIG. 7, it can further be seen that the textile material 4 is a woven fabric 4a in whose supporting zone 5, the conductor strands 2 are interlaced with the individual fibers 6.

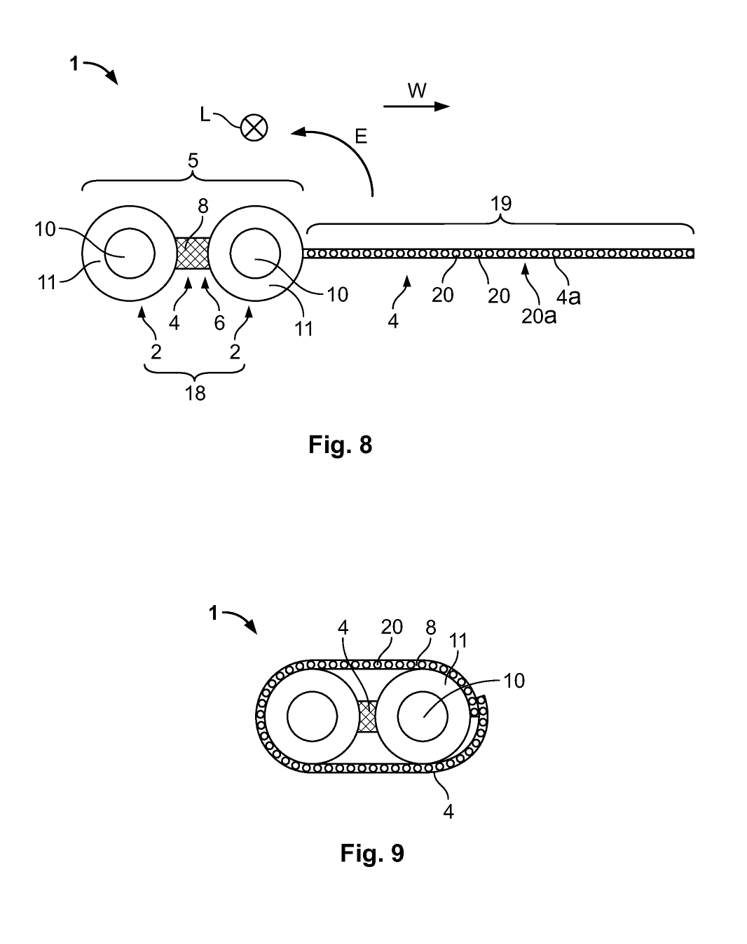

Now with reference to FIGS. 8 and 9, the cable assembly 1 is shown in a pre-assembled state (FIG. 8), prior to shaping the textile material 4, and in the assembled state shown in FIG. 9.

In the cross-sectional view of FIG. 8, two conductor strands 2, each having a lead 9 that is surrounded by an insulating coating 11, are arranged substantially parallel and along longitudinal length L side by side and adjacent to one another. In the supporting zone 5 of the cable assembly 1, the conductor strands 2 are integrated in the textile material 4 that includes a single type fiber material 6. The two conductor strands 2 form a cable pair 18.

The textile material 4 is positioned adjacent to one of the conductor strands 2 forming the cable pair 18, and continues to an extent such that, when wrapped around the cable pair 18 in an enshrouding direction E, the textile material 4 can be wrapped around the cable pair 18 at least once for encapsulating the cable pair 18, as shown in FIG. 9. In the part of the textile material 4 that is adjacent to the cable pair 18, the textile material 4 includes an elastic metalized yarn 20a interlaced in a structure of the woven fabric 4a. This section of the textile material 4 forms an electromagnetic shielding zone 19 that, due to the metalized yarns 20a, which are conductive fibers 20, protects the cable pair 18 in the assembled state from electromagnetic radiation from the outside.

In the shown embodiment, the conductive fibers 20 are elastic fibers 20a which provide the shielding zone 19 with an elastic property making it possible to tightly wrap the shielding zone 19 around the cable pair 18, and keep the shielding zone 19 in the assembled state shown in FIG. 9. Due to the stretching property of the shielding zone 19 the distance between the conductor and the shield always stays equal, even if the cable assembly 1 bends which is advantageous with respect to impedance of the cable assembly 1.

As an alternative to using an elastic metalized yarn 20a, one metalized fiber and another elastic fiber in the shielding zone 19 may be used.

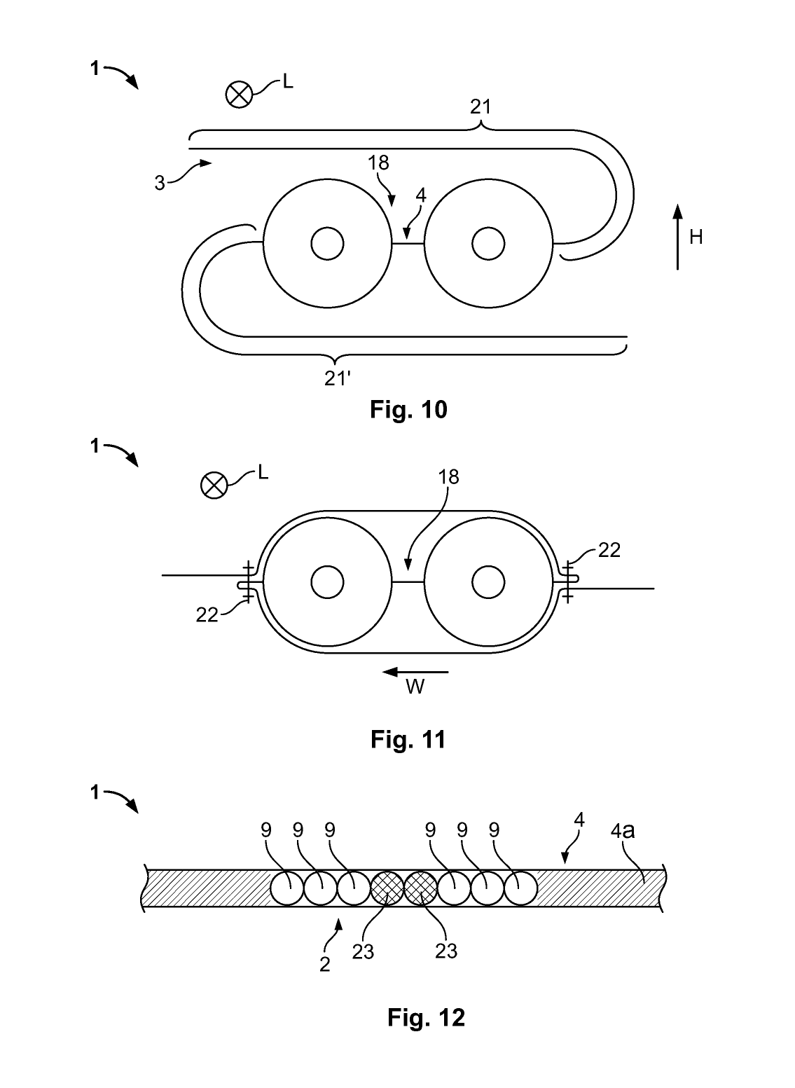

Now with reference to FIGS. 10 and 11, the cable assembly 1 includes a cable pair 18, whose strands 2 are integrated in the textile material 4 adjacent to one another. The shown cable assembly 1 does not include a shielding zone 19. Rather, the flexible support 3 includes an electrically insulating jacket 21 extending in along the width W of the textile material 4 to both sides of the cable pair 18. The textile material 4 in the jacket 21 includes electrically insulating fibers 6 so that, when the jacket 21 is surrounding the conductor strands 2, an insulation thereof against the outside is achieved. For coating the cable pair 18 with the two jackets 21, 21′ of the textile material 4, one of the jackets 21 is folded, in the height direction H of the cable assembly 1, above the cable pair 18, while the other jacket 21′ is folded, in the height direction H, under the cable pair 18. By shaping the textile material 4, i.e. by folding the textile material 4 such that jackets 21, 21′ are placed as top and bottom layers above and below a cable pair 18, the cable pair 18 can be electrically insulated. The adjacent layers of the flexible support 3, i.e. the top and the bottom layer of textile material 4, respectively, are joined together to keep the cable assembly 1 assembled. In the shown embodiment, the jackets 21, 21′ are joined by stitching a seam 22 running substantially in the longitudinal direction L adjacent to each side of the cable pair 18.

Instead of stitching the adjacent layers of the textile material 4, they could also be stapled or using any other joining technology known to the art, including but not limited to clamping.

Even though the cable pair 18 is enshrouded using an electrically insulating jacket 21, as shown in FIGS. 10 and 11, the same folding technique could be used to provide a shielding. In such a case, the jackets 21, 21′ would be designed as shielding zones 19 having a electrically conductive fiber material. For closing the shielding, an electrically conductive fiber material could be used for the seam 22.

As shown in FIG. 12, the cable assembly 1 includes two different types of conductor strands 2, namely electrical wires 9 as well as optical fibers 23 that are arranged in a defined conductor pattern 12 with the individual conductor strands 2 running substantially parallel and adjacent to one another. Thus, the cable assembly 1 is of a hybrid type having electrical wires 9 as well as optical conductors 23.

One problem with optical fibers 23 made from glass is that the thermal properties of glass are different from materials that are commonly used in cables or optical flexible foils. When the commonly used materials start to shrink, the optical fiber 23 “grows” out of the cable resulting in a micro-bend and thus an additional loss of transmission.

By weaving optical fibers 23 as conductor strands 2 into a textile material 4, problems associated with micro-bends can be solved by an appropriate choice of fiber material 6 that matches the thermal property of glass fibers 23. If, for example, silica yarns are used as yarn 6 of the textile material 4, which have similar thermal properties as glass fibers 23, the problem of micro-bends is solved.

Other functionalized fibers, such as very strong aramide fibers 7, could be added and used in the woven fabric 4a, providing a protection for the fragile optical fibers 23.

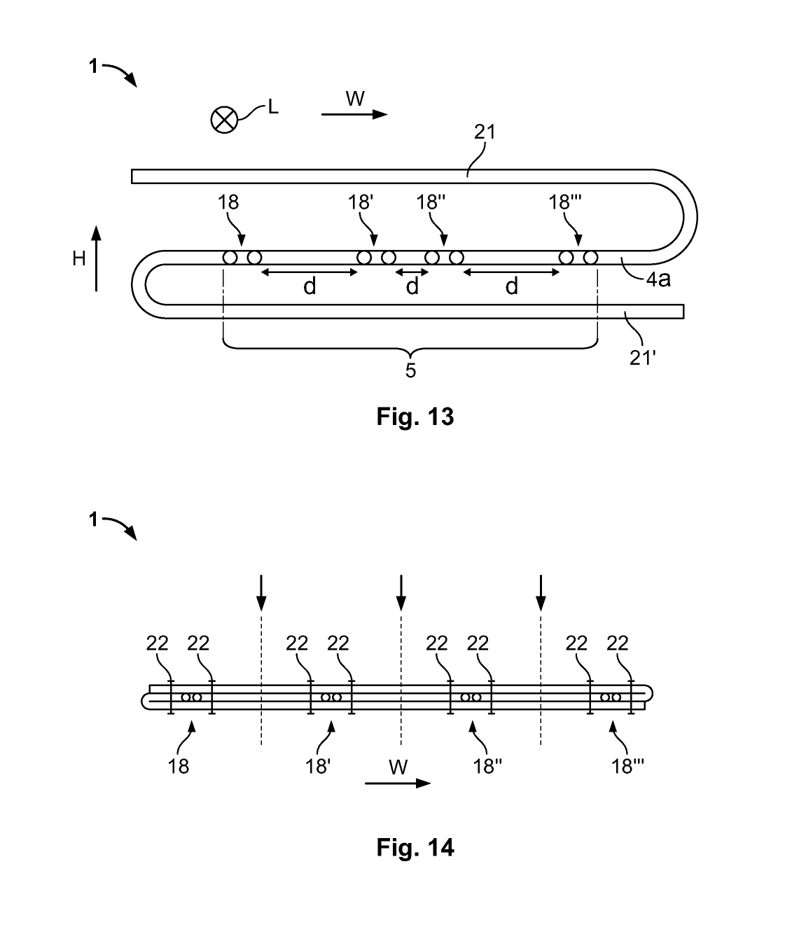

Now with FIGS. 13 and 14, the cable assembly 1 includes a plurality of cable pairs 18, 18′, 18″ and 18′″ that are integrated into the woven fabric 4a in the supporting zone 5. The individual cable pairs 18, 18′, 18″, 18′″ are spaced from one another by a distance D along the width W of the textile material 4 so that the conductor pattern 12 of the cable assembly 1 includes four individual cable pairs 18. Two jackets 21, 21′ are provided on both sides of the supporting zone 5, which jackets 21, 21′ are folded above and under the supporting zone 5 for coating the four cable pairs 18, 18′, 18″, 18′″.

In the cable assembly 1 as shown in FIG. 14, seams 22 are placed adjacent to one another, thereby forming the jacket 21 around each of the cable pairs 18, 18′, 18″, 18′″. Thereafter, the individual cable pairs 18 are separated by cutting the cable assembly 1 and dividing it into subunits at the dashed lines, as indicated by the arrows in FIG. 14. Thereby, a plurality of cable pairs 18, 18′, 18″, 18′″ can be easily and simultaneously produced using the method.

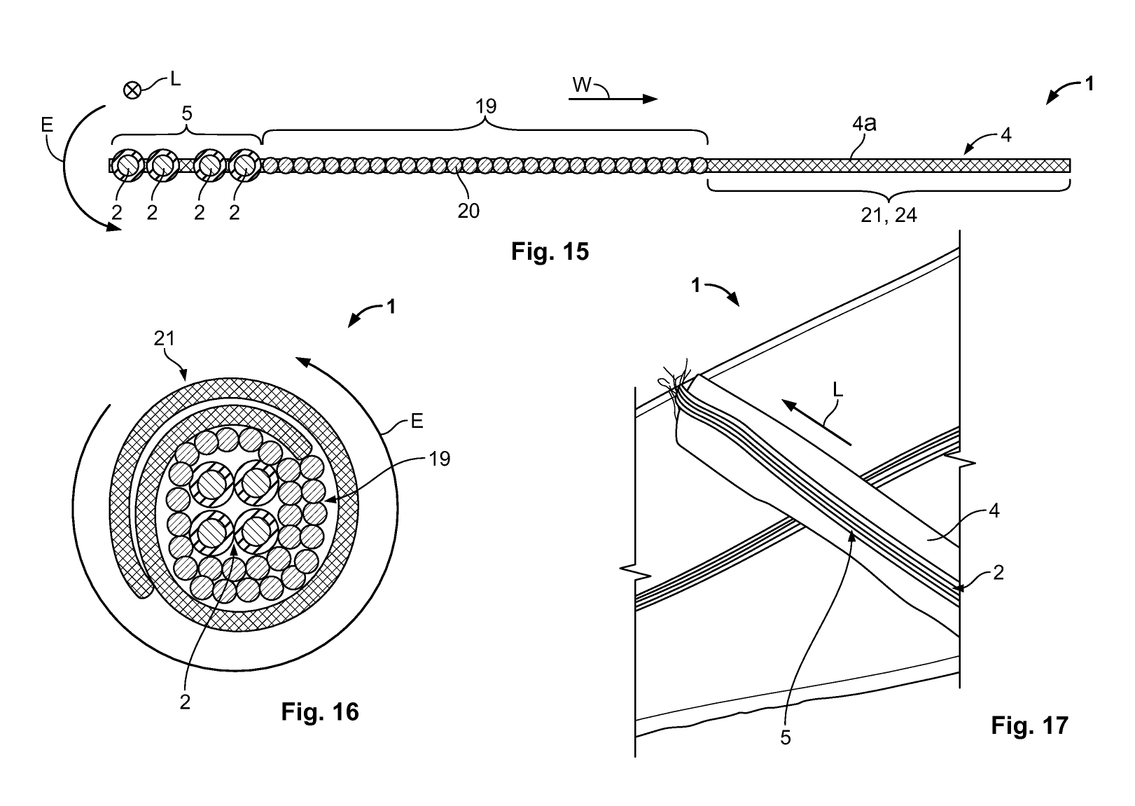

With respect to FIGS. 15 and 16, the cable assembly 1 is shown, to which a part of the textile material 4 is wrapped around the conductor strands 2, such that a shielded and an isolated cable having four leads is produced.

As shown in FIG. 15, the flexible support 3 is the substantially planar woven fabric 4a. At one lateral side thereof, four conductor strands 2 are woven into the textile material 4. The four conductor strands 2 substantially run in the longitudinal direction parallel and adjacent to each other. The distance between the second and the third conductor strands 2 is larger than the distance between the first and the third and the third and the forth conductor strands 2. The textile material 4 between the second and the third conductor strands 2, upon shaping the textile material 4 into the assembled state shown in FIG. 16 by wrapping the planar woven fabric 4a in the enshrouding direction E, acts as a hinge allowing the arrangement of the four conductor strands 2 in two rows of two strands 2 on top of each other. In the width direction W adjacent to the fourth of the conductor strands 2, the woven fabric 4a is, at least partially, composed of conductive fibers 20 forming a shielding zone 19 following the supporting zone 5. If continuing to wrap the textile material 4 in the enshrouding direction E, the shielding zone 19 is wrapped around all four conductor strands 2 providing a shielding for these strands 2, as can be seen in FIG. 16.

As shown in FIG. 16, a jacket 21 having an electrically insulating fiber material is provide along the width direction W after the shielding zone 19. The jacket 21 is wrapped around the shielding zone 19 and consequently also around the supporting zone 5 with the conductor strands 2.

For improving the durability of said cable assemblies 1, the jacket 21 may also include durable fibers 6 having a good wear resistance providing a protecting of the cable assembly 1. In such case, the jacket 21 is at the same time a stabilization zone 24 having an improved wear resistance compared to the flexible support 3 outside the stabilization zone 24.

As shown in FIG. 17, an exemplary embodiment of the cable assembly 1 is shown, in which conductor strands 2 are arranged substantially running along the longitudinal direction L of the textile material 4 and woven into the textile material 4.

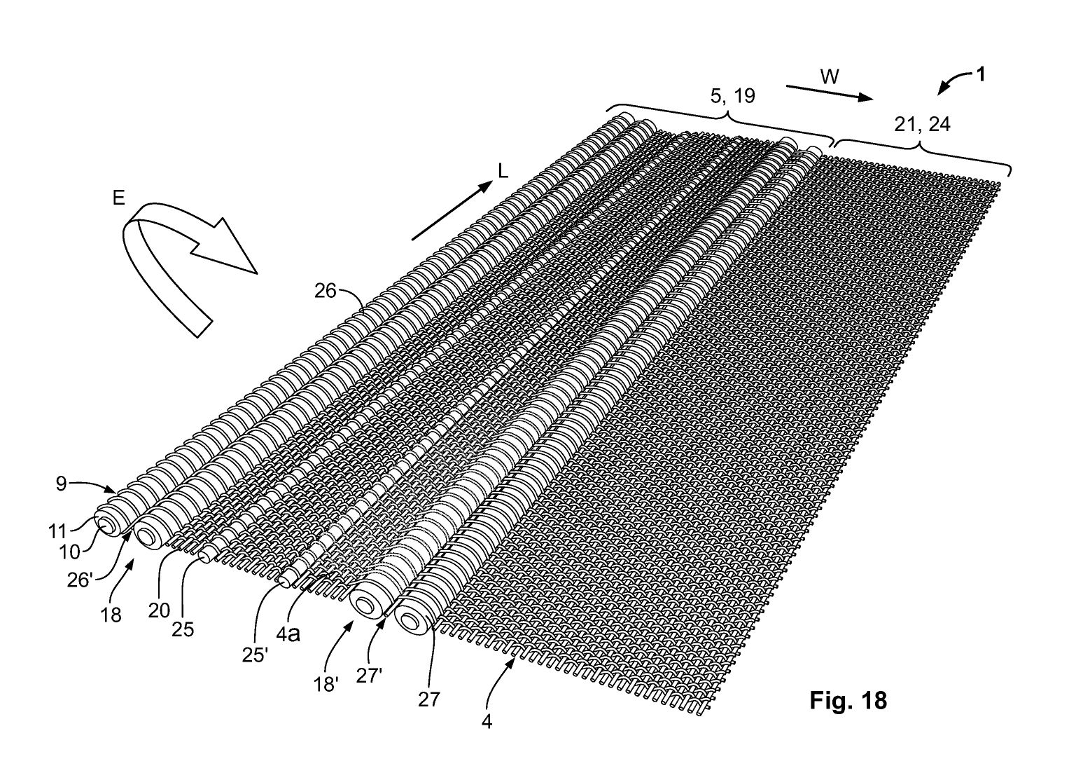

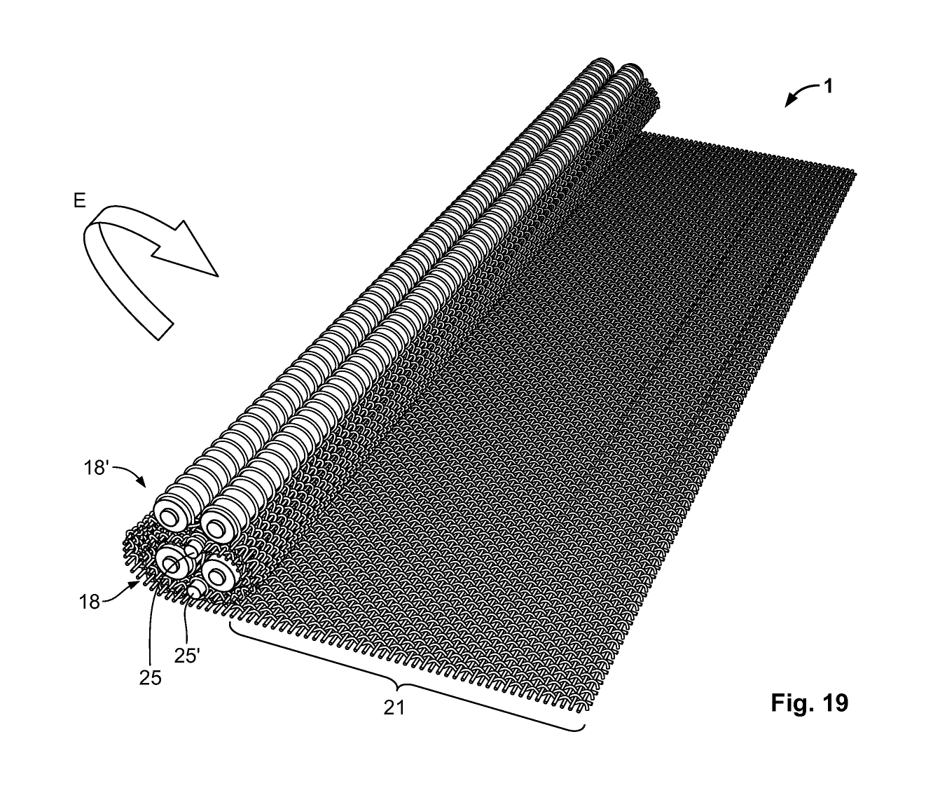

Now with reference to FIGS. 18 and 19, the cable assembly 1 is shown having a cable having two shielded parallel cable pairs 18, 18′ with drain wires 25, 25′. In the supporting zone 5 of the textile material 4 between the two cable pairs 18 and 18′, two drain wires 25 are arranged. All electrical wires 9 and drain wires 25 are woven substantially along the longitudinal direction L in parallel to each other into the woven fabric 4a. When wrapping the cable assembly 1, the first cable pair 18 is folded such that the cable pair 18 is placed on top of the first drain wire 25 such that the drain wire 25 is positioned in a gap 26 between the two parallel conductor strands 2 of the cable pair 18. Upon further wrapping the textile material 4, the other, second drain wire 25′ is placed adjacent to the cable pair 18 at a gap 26′ opposite to the gap 26 shown in FIG. 18, as can be seen in FIG. 19.

When continuing to wrap the textile material 4 in the enshrouding direction E, the second cable pair 18′ is placed on top of the first cable pair 18 such that the first drain wire 25 is positioned in the gap 27 between the conductor strands 2 of the second cable pair 18′. Due to the conductor pattern 12 of the two cable pairs 18, 18′ and the two drain wires 25, 25′, upon wrapping the textile material 4, the two cable pairs 18 are placed on top of each other with one drain wire 25 arranged in the centre of the four conductor strands 2 and the other drain wire 25′ adjacent to the cable pair 18.

The supporting zone 5, where the conductor strands 2 and the drain wires 25, 25′ are integrated into the textile material 4, includes electrical conductive fibers 20 so that the supporting zone 5 is at the same time a shielding zone 19. Thus, when wrapping the textile material 4 as shown in FIGS. 18 and 19 along the enshrouding direction E, the textile material 4 in the shielding zone 19 at the same time shields the first cable pair 18 from the second cable pair 18′.

The remainder of the textile material 4 that follows the second cable pair 18 is designed as a jacket 21 that is strengthened by using resistant fibers, such as aramide fibers and hence, simultaneously provides a stabilization zone 24 for protecting the cable assembly 1. When continuing to wrap the textile material 4 in the enshrouding direction E, as indicated in FIG. 19, the jacket 21 and stabilization zone 24 is completely wrapped around the supporting zone 5 with the conductor strands 2 and the drain wires 25, 25′, thereby providing an outer insulation and protective jacket of the cable assembly 1.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention. For instance, different natural and synthetic fibers that can be used and be arbitrarily combined with one another allow the flexible support to be selected that has the properties necessary for guaranteeing functionality of the cable assembly to be produced. Further, a lot of textile materials can be used that are natural materials and thus environmentally friendly.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A cable assembly comprising:
a plurality of conductor strands;
a flexible support having a textile material into which the plurality of conductor strands are integrated and secured.

2. The cable assembly according to claim 1, wherein the plurality of conductor strands are woven into the textile material.

3. The cable assembly according to claim 1, wherein the textile material is a woven fabric.

4. The cable assembly according to claim 1, wherein the flexible support includes a stabilization zone having a jacket.

5. The cable assembly according to claim 1, wherein the textile material includes conductive fibers.

6. The cable assembly according to claim 1, wherein the flexible support includes an electrically insulating jacket.

7. The cable assembly according to claim 6, wherein the electrically insulating jacket is positioned about the plurality of conductor strands.

8. The cable assembly according to claim 7, wherein the textile material is positioned about the plurality of conductor strands and the electrically insulating jacket is positioned about the textile material.

9. The cable assembly according to claim 1, wherein the plurality of conductor strands includes an electrical wire.

10. The cable assembly according to claim 9, wherein the plurality of conductor strands includes an optical fiber arranged substantially parallel and adjacent to the electrical wire.

11. The cable assembly according to claim 9, wherein the plurality of conductor strands run substantially parallel and adjacent to one another.

12. The cable assembly according to claim 1, wherein the plurality of conductor strands includes an optical fiber.

13. The cable assembly according to claim 1, wherein the plurality of conductor strands run substantially parallel and adjacent to one another.

14. A method for producing a cable assembly, comprising the steps of:
providing a plurality of conductor strands;
integrating the plurality of conductor strands into a flexible support having a textile material, and
shaping the textile material.

15. The method for producing the cable assembly according to claim 14, wherein the plurality of conductor strands are weaved into the textile material.

16. The method for producing the cable assembly according to claim 14, wherein the textile material is shaped by wrapping or folding.

17. The method for producing the cable assembly according to claim 14, further comprising a step of shielding the plurality of conductor strands by positioning the textile material around the plurality of conductor strands.

18. The method for producing the cable assembly according to claim 14, further comprising a step of positioning an electrically insulating jacket of the textile material about the plurality of conductor strands.

19. The method for producing the cable assembly according to claim 14, further comprising a step of joining adjacent layers of the flexible support for fixing the textile material.

20. The method for producing the cable assembly according to claim 19, wherein the adjacent layers are stitched together.

21. The method for producing the cable assembly according to claim 14, wherein the plurality of conductor strands includes an electrical wire.

22. The method for producing the cable assembly according to claim 21, wherein the plurality of conductor strands includes an optical fiber arranged substantially parallel and adjacent to the electrical wire.

23. The method for producing the cable assembly according to claim 21, wherein the plurality of conductor strands run substantially parallel and adjacent to one another.

24. The method for producing the cable assembly according to claim 14, wherein the plurality of conductor strands includes an optical fiber.

25. The method for producing the cable assembly according to claim 14, wherein the plurality of conductor strands run substantially parallel and adjacent to one another.
